(19) United States
(12) Patent Application Publication
(10) Pub. No.: US 2005/0152057 A1
(43) Pub. Date: Jul. 14, 2005

(54) Methods for tighter thresholds in rotatable storage media

(76) Inventor: Thorsten Schmidt, Milpitas, CA (US)

Correspondence Address: FLIESLER MEYER, LLP, FOUR EMBARCADERO CENTER, SUITE 400, SAN FRANCISCO, CA, 94111, US

(21) Appl. No.: 10/756,065

(22) Filed: Jan. 13, 2004

(51) Int. Cl. G11B 19/04; G11B 5/596

(52) U.S. Cl. 360/60; 360/77.08

(57) ABSTRACT

Systems and methods in accordance with embodiments can be used to execute data transfer operations in systems and devices including rotatable storage media, such as hard disk drives. During a data transfer operation following a seek, shock, or fault, for example, a first set of thresholds is used for a specified time to determine whether to read data from or write data to the media, after which a second set of thresholds can be used. The second thresholds can be tighter than the first set of thresholds used during drive operation. In this manner, increased reliability and performance during data transfer operations can be achieved.

### CROSS-REFERENCED CASES

The following applications are cross-referenced and incorporated herein by reference:

U.S. patent application Ser. No. ______ (Attorney Docket No. PANA-01080US0), entitled SYSTEMS FOR TIGHTER THRESHOLDS IN ROTATABLE STORAGE MEDIA, by Thorsten Schmidt, filed concurrently.

### FIELD OF THE INVENTION

The present invention relates to data transfer operations in devices including rotatable storage media. The present invention further relates to preventing or stopping the reading or writing of data while a head or write element is not within a threshold and improvements in the thresholds used to determine when to prevent or stop reading or writing data.

### BACKGROUND

Rotatable storage media devices, such as magnetic disk drives and optical disk drives, are an integral part of computers and other devices with needs for large amounts of reliable memory. Rotatable storage media devices are inexpensive, relatively easy to manufacture, forgiving where manufacturing flaws are present, and capable of storing large amounts of information in relatively small spaces.

A typical device having a rotatable storage medium includes a head disk assembly and electronics to control operation of the head disk assembly. The head disk assembly can include one or more disks. In a magnetic disk drive, a disk includes a recording surface to receive and store user information. The recording surface can be constructed of a substrate of metal, ceramic, glass or plastic with a very thin magnetizable layer on either side of the substrate. Data is transferred to and from the recording surface via a head mounted on an actuator assembly. Heads can include one or more read and/or write elements, or read/write elements, for reading and/or writing data. Drives can include one or more heads for reading and/or writing. In magnetic disk drives, heads can include a thin film inductive write element and a magneto-resistive read element.

Disk drives can operate in one or more modes or operations. In a first mode or operation, often referred to as seek or seeking, a head moves from its current location, across a disk surface to a selected track. In a second mode, often referred to as track following, a head is positioned over a selected track for reading data from a track or writing data to a track.

In order to move a head to a selected track or to position a head over selected tracks for writing and reading, servo control electronics are used. In some disk drives, one disk can be dedicated to servo information. The servo disk can have embedded servo patterns that are read by a head. Heads for data disks can be coupled to the servo disk head to be accurately positioned over selected tracks. In other disk drives, servo information can be embedded within tracks on the medium at regular intervals. Servo information is read as a head passes over a track to accurately position the head relative to a track.

While servo-positioning circuitry is generally accurate, heads can drift from desired locations during track following operations. Reading or writing data during inaccurate head positioning can have adverse affects on drive performance.

During write and read operations, the drive attempts to keep the head or element as close to the center of a selected data track as possible. Data written while the write element is positioned away from a track centerline can later be difficult to read, possibly resulting in transfer errors. Furthermore, data written away from a track centerline can corrupt data on other tracks as well as interfere with reading of data on other tracks.

In modern disk drives, tracks are placed increasingly closer together to increase data storage capacity. Narrower tracks are often used in order to increase the tracks per inch (TPI) on a disk. Measures can be used in drives to ensure that reliability and performance are maintained as data storage capacity increases.

### BRIEF DESCRIPTION OF THE DRAWINGS

FIG. 1 is a diagram showing components of an exemplary disk drive that can be used in accordance with one embodiment of the present invention.

FIG. 2 is a top view of a rotatable storage medium that can be used in the drive of FIG. 1.

FIG. 3 is an illustration of a track of the medium of FIG. 2.

FIG. 4 is an illustration of a servo sector of the track of FIG. 3.

FIG. 5 is a servo pattern that can be used to identify tracks on the medium of FIG. 2.

FIG. 6 is a servo pattern that can be used to identify tracks on the medium of FIG. 2, wherein thresholds are illustrated with respect to track centerlines.

FIG. 7 is a graph illustrating an exemplary position error signal plotted against time as a head of a disk drive settles onto a selected track in order to enter a track following mode for reading or writing data on the selected track.

FIG. 8 is a servo pattern that can be used to identify tracks on the medium of FIG. 2, wherein two sets of thresholds are illustrated with respect to track centerlines.

FIG. 9 is a flowchart in accordance with an embodiment for executing a data transfer operation in a system including a rotatable storage medium.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In the following description, various aspects of the present invention will be described. However, it will be apparent to those skilled in the art that the present invention may be practiced with only some or all aspects of the present invention. For purposes of explanation, specific numbers, materials, and configurations are set forth in order to provide a thorough understanding of the present invention. However, it will be apparent to one skilled in the art that the present invention may be practiced without the specific details. In other instances, well-known features are omitted or simplified in order not to obscure the present invention.

Parts of the description will be presented in data processing terms, such as data, selection, retrieval, generation, and so forth, consistent with the manner commonly employed by those skilled in the art to convey the substance of their work to others skilled in the art. As well understood by those skilled in the art, these quantities take the form of electrical, magnetic, or optical signals capable of being stored, transferred, combined, and otherwise manipulated through electrical, optical, and/or biological components of a processor and its subsystems.

Various operations will be described as multiple discrete steps in turn, in a manner that is most helpful in understanding the present invention, however, the order of description should not be construed as to imply that these operations are necessarily order dependent.

Various embodiments will be illustrated in terms of exemplary classes and/or objects in an object-oriented programming paradigm. It will be apparent to one skilled in the art that the present invention can be practiced using any number of different classes/objects, not merely those included here for illustrative purposes. Furthermore, it will also be apparent that the present invention is not limited to any particular software programming language or programming paradigm.

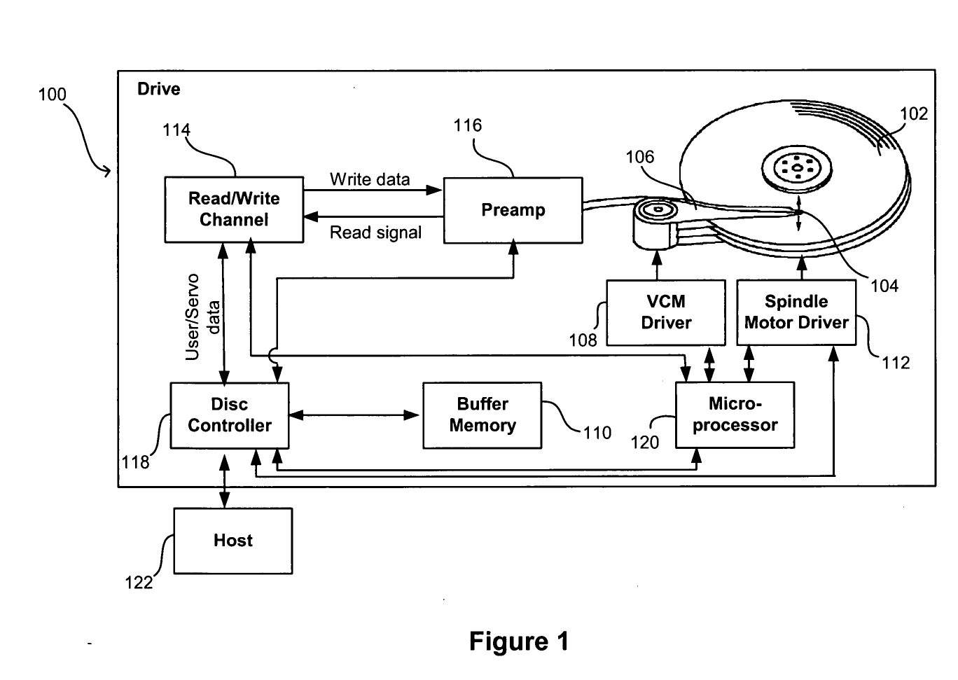

Systems and methods in accordance with one embodiment of the present invention can be used when writing and attempting to write user data to a rotatable storage medium in a data storage device, such as a hard disk drive. Although the following description is provided using a hard disk drive, it will be understood that the principles, systems, and methods can be used in any device including a rotatable storage medium. For example, a typical disk drive 100, as shown in FIG. 1, includes at least one magnetic disk 102 capable of storing information on at least one of the surfaces of the disk. A closed-loop servo system can be used to move an actuator arm 106 and data head 104 over the surface of the disk, such that information can be written to, and read from, the surface of the disk. The closed-loop servo system can contain, for example, a voice coil motor driver 108 to drive current through a voice coil motor (not shown) in order to drive the actuator arm, a spindle motor driver 112 to drive current through a spindle motor (not shown) in order to rotate the disk(s), a microprocessor 120 to control the motors, and a disk controller 118 to transfer information between the microprocessor, buffer, read channel, and a host 122. A host can be any device, apparatus, or system capable of utilizing the data storage device, such as a personal computer or Web server.

The drive can contain at least one processor, or microprocessor 120, that can process information for the disk controller 118, read/write channel 114, VCM driver 108, or spindle driver 112. The microprocessor can also include a servo controller, which can exist as an algorithm resident in the microprocessor 120. The disk controller 118, which can store information in buffer memory 110 resident in the drive, can also provide user data to a read/write channel 114, which can send data signals to a current amplifier or preamp 116 to be written to the disk(s) 102, and can send servo and/or user data signals back to the disk controller 118. In one embodiment buffer memory 110 can be cache memory such as SRAM or DRAM. Microprocessor 120 can further include internal memory such as cache memory. In some embodiments, the drive can further include a non-volatile memory (not shown) such as flash memory that be accessed by the microprocessor or disk controller.

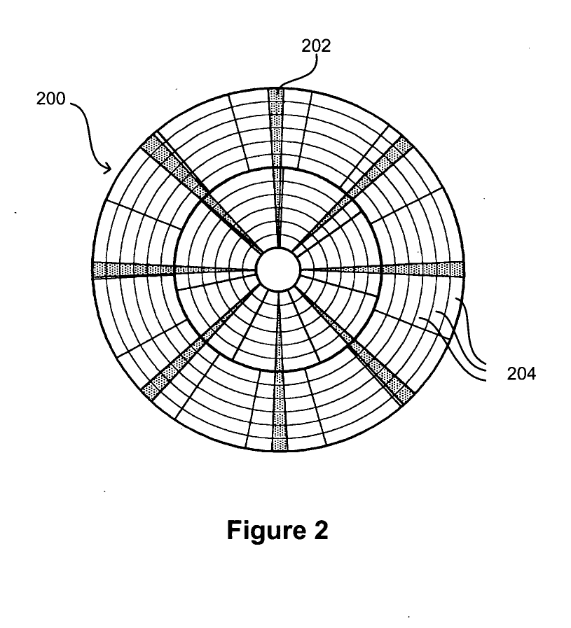

The information stored on such a disk can be written in concentric tracks, extending from near the inner diameter of the disk to near the outer diameter of the disk 200, as shown in the exemplary disk of FIG. 2. In an embedded servo-type system, servo information can be written in servo wedges 202, and can be recorded on tracks 204 that can also contain data. In a system where the actuator arm rotates about a pivot point such as a bearing, the servo wedges may not extend linearly from the inner diameter (ID) of the disk to the outer diameter (OD), but may be curved slightly in order to adjust for the trajectory of the head as it sweeps across the disk.

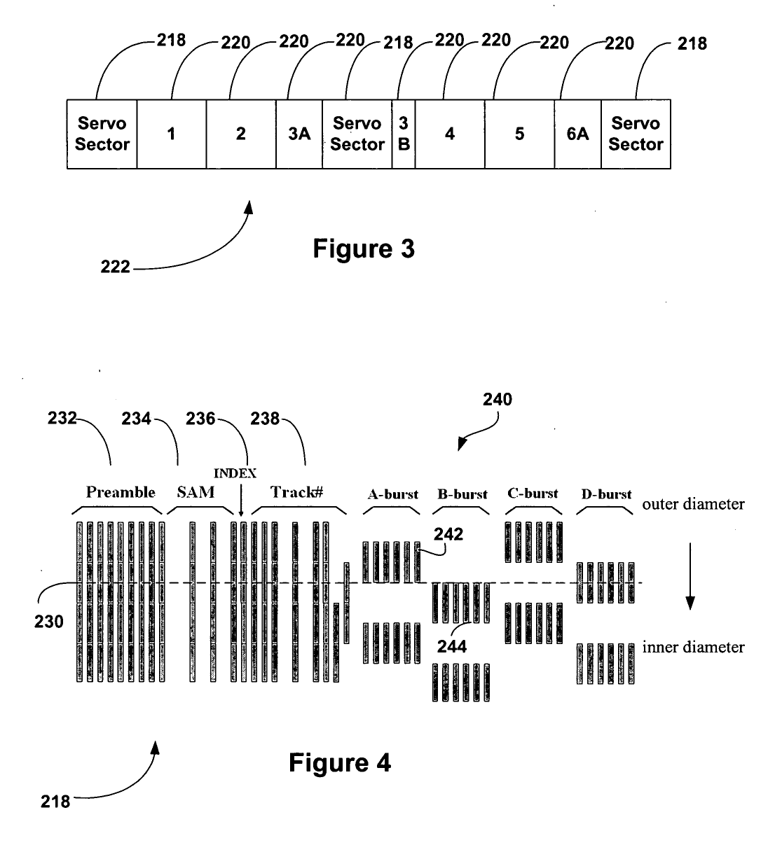

An exemplary track 222 of storage disk 200 is illustrated in FIG. 3. Servo sectors 218 split the track 222 into multiple data sectors 220. Each servo sector 218 is associated with the immediately following data sectors 220, as defined by a direction of rotation of disk 200. As is illustrated, servo sectors can split data sectors resulting in a non-integer number of data sectors between servo wedges. The number of tracks may vary by embodiment. In one embodiment, for example, the number exceeds two thousand.

The servo information often includes servo bursts that can form transitions or boundaries. A boundary or burst boundary as used herein does not mean or imply that servo bursts forming a boundary necessarily have a substantially common edge as the bursts can be spaced such that there is a gap radially or circumferentially between the bursts. The servo information can be positioned regularly about each track, such that when a data head reads the servo information, a relative position of the head can be determined and that determination can be used by a servo controller to adjust the position of the head relative to the track. For each servo wedge, this relative position can be determined in one example as a function of the target location, a track number read from the servo wedge, and the amplitudes or phases of the bursts, or a subset of those bursts. The position of a head or element, such as a read/write head or element, relative to a target or desired location such as the center of a track or other desired location, will be referred to herein as position-error. Position-error distance may be used to refer to the distance between a target or desired location and an actual or predicted location of a head or element. The signal generated as a head or element moves across servo bursts or boundaries between servo bursts is often referred to as a position-error signal (PES). The PES can be used to represent or indicate a position of the head or element relative to a target location such as a track centerline identified by a boundary between servo bursts.

An exemplary servo sector 218 is illustrated in FIG. 4. The servo information shown includes a preamble 232, a servo address mark (“SAM”) 234, an index 236, a track number 238, and servo bursts 240-246. These fields are exemplary, as other fields may be used in addition to, or in place of, the exemplary fields, and the order in which the fields occur may vary. The preamble 232 can be a series of magnetic transitions, which can represent the start of the servo sector 218. In the servo sector of FIG. 4, the SAM 234 specifies the beginning of available information from the servo sector 218. The track number 238, usually gray coded, is used for uniquely identifying each track. Servo bursts 240 are positioned regularly about each track, such that when a data head reads the servo information, a relative position of the head can be determined that can be used by a servo processor to adjust the position of the head relative to the track. This relative position can be determined by looking at the PES value of the appropriate bursts. The PES can also be used to predict a position of a head or element. Sampled PES values over time, for example, can be used to determine a predicted position of an element. Given a previously determined or known position, velocity of an element can be multiplied by time to determine a distance an element has traveled or will travel to predict an element position. Velocity can be determined in one embodiment by taking two servo position readings as the head moves along a track in order to obtain a radial distance. By dividing by a time to move the radial distance, a head, element, or actuator arm velocity can be determined. Filtering techniques can be used to achieve greater accuracy in velocity calculations. Many other methods for determining a velocity can be used in accordance with embodiments of the present invention, including, for example, observer systems.

A centerline 230 for a given data track can be “identified” relative to a series of bursts, burst edges, or burst boundaries, such as a burst boundary defined by the lower edge of A-burst 242 and the upper edge of B-burst 244 in FIG. 4. The centerline can also be defined by, or offset relative to, any function or combination of bursts or burst patterns. For example, if the destination is a write center, a location at which the PES value is zero defines the center of the write track. Any location relative to a function of the bursts can be selected to define track position. For example, if a read head evenly straddles an A-burst and a B-burst, or portions thereof, then servo demodulation circuitry in communication with the head can produce equal amplitude measurements for the two bursts, as the portion of the signal coming from the A-burst above the centerline is approximately equal in amplitude to the portion coming from the B-burst below the centerline. The resulting computed PES can be zero and represent a position at track center if the radial location defined by the A-burst/B-burst (A/B) combination, or A/B boundary, is the center of a data track, or a track centerline. In such an embodiment, the radial location at which the PES value is zero can be referred to as a null-point. Null-points can be used in each servo wedge to define a relative position of a track. If the head is too far towards the outer diameter of the disk, or above the centerline in FIG. 4, then there will be a greater contribution from the A-burst that results in a more “negative” PES. Using the negative PES, the servo controller could direct the voice coil motor to move the head toward the inner diameter of the disk and closer to its desired position relative to the centerline. This can be done for each set of burst edges defining the shape of that track about the disk.

The servo scheme described above is one of many possible schemes for combining the track number read from a servo wedge and the phases or amplitudes of the servo bursts. Many other schemes are possible that can be used in accordance with various embodiments.

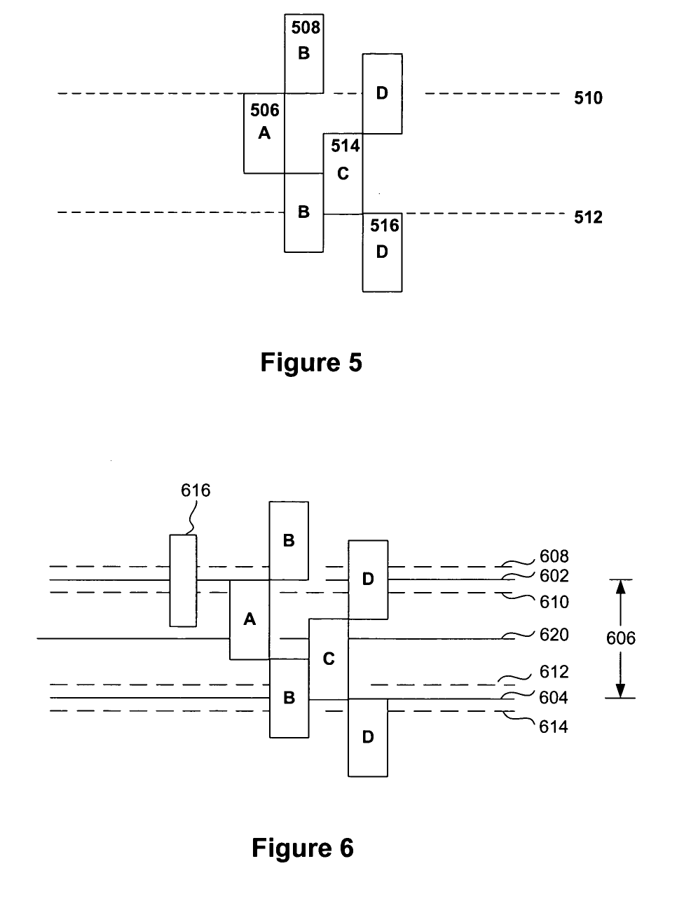

Despite the use of servo positioning information to control head position, heads of disk drives often move in relation to centerlines of selected tracks while reading data from a track or writing data to a track. Referring now to FIG. 5, there is shown an exemplary servo pattern that can be used to identify data tracks on a rotatable storage media. Other track formats and servo patterns can be used in accordance with other embodiments. A-burst 506 and B-burst 508 can identify a centerline 510 of a data track, while C-burst 514 and D-burst 516 can identify a centerline 512. Centerlines can be written or calculated. In an exemplary disk drive, a written centerline can be defined by a written burst pattern. In another exemplary disk drive, a calculated or averaged centerline can be determined from variations in written servo bursts. An averaged or calculated track centerline can be used to remove some effects of written and repeatable runout caused by misplaced heads during servo writing. In the servo pattern example shown, often referred to as a 3-step or 3-pass per track 2-burst track center servo pattern, the widths of the data tracks are equal to 3/2 times the widths of the servo tracks or servo bursts. In other embodiments, servo bursts can be equal to or larger than data tracks. The spacing oftracks on disk 202 can be defined by these burst patterns, and is generally referred to as track pitch. Track pitch may be defined in various ways. Track pitch can refer to a distance between theoretical track centers, e.g., the distance between lines 510 and 512. It may also refer to a distance between track boundaries or the distance between a top portion of an erase band on one side of a track and a top portion of an erase band on an opposite side of the track. In the example shown, the servo track TPI is equal to 3/2 times the data track TPI. In other embodiments, servo track TPI can be equal to data track TPI. Servo track TPI may be any fraction or multiple of a data track TPI.

The path of a head following a track having centerline 510 may vary radially from the written or calculated centerline of the track. This may cause reading of data in adjacent tracks, reading of erroneous data, writing unreadable data, or writing data into adjacent tracks. To prevent these negative effects on drive performance, thresholds can be used.

The location of heads or elements during seek operations and during the transition between seek operations and track-following operations is also important. During a seek, a selected head is moved to a target track on the corresponding disk surface. A velocity profile or estimation can define a desired head trajectory as the head is accelerated and decelerated in order to place the head over the target track. As the head nears the destination track, a settling mode can be entered to settle the head onto the target track. After settling, the servo system can enter the track following mode to maintain the head over the target track for reading and/or writing. In order to ensure reliable reading and writing of data on selected tracks, criteria can be established to determine when a seek and/or settle mode should end and a track following mode begin. The criteria used to determine when to shift from a seek and/or settle mode to a track following mode is often referred to as end-of-seek criteria. In some embodiments, settling is not a separate mode and is part of the seek mode.

In one embodiment, thresholds and end-of-seek criteria can be stored on a selected portion of the disk or stored in some nonvolatile memory such as flash memory within the drive. Thresholds and end-of-seek criteria can be loaded into a faster memory such as SRAM or DRAM on start up of a drive to increase performance. Servo control circuitry, such as a controller, processor, or algorithm resident in a processor or controller can access the thresholds and end-of-seek criteria to use during drive operations.

Write-stop thresholds can be used to inhibit, stop, and/or interrupt writing during a data write operation, as the results of such write operations can be unreliable, and such write operations can possibly damage previously written data to one or more other tracks such as those tracks adjacent the target track. Read-stop thresholds can be used to inhibit, stop, and/or interrupt reading during a read operation due to read threshold crossings. The reason for doing this is to prevent the drive from reading data from the adjacent track. This may not be necessary in some drives that have an ASIC/Data Format combination that ensures against accidentally reading adjacent track data and sending it to the host.

Thresholds can be expressed in numerous ways. Thresholds can be expressed as a state ofthe system in which they are being used. If a measured or predicted state ofthe system is not within the threshold state, a corresponding operation of the system can be inhibited. In one embodiment, for example, a threshold can be expressed as a distance or a combination of distance and head or element velocity. In other embodiments, thresholds can be expressed as a percentage or fraction of track pitch or width. A threshold expressed as a distance or percentage of track pitch can define a zone about the center of a track in which safe reading and/or writing can take place. Thresholds can be expressed in many alternative forms and be used to interrupt operations when a state of a system including a rotatable storage medium is not within the threshold state.

In one embodiment, a data transfer operation, including a read or write operation, can be inhibited when a distance of a head or element from a track centerline is greater than or equal to a threshold distance from the centerline. In another embodiment, an operation can be inhibited when a position of a head or element, a measured position of a head or element, or a predicted position of a head or element reaches or exceeds a threshold position. In yet another embodiment, writing or reading can be inhibited when a head or element is not within a defined safe zone about the center of a track. For example, a write stop threshold may be expressed as 10% of the track pitch. Write operations can be enabled when the head or element is within the safe zone identified by the thresholds, i.e. when the head or element (or portion thereof) is less than 10% of the track pitch (width) away from the centerline. During a write operation, the servo controller can monitor head or element position (such as by monitoring the PES) and inhibit or interrupt the operation if the threshold is reached or exceeded. Data transfer operations, as used herein, can include writing and/or reading data as well as positioning a head or element prior to beginning writing and/or reading.

FIG. 6 illustrates an exemplary servo pattern that can be used to identify data track centerlines 602 and 604. Using the term track pitch to refer to the distance between centerlines of tracks, the track pitch for this combination is shown as reference 606. Thresholds 608-614 can be chosen at distances equal to 10% of the track pitch from the centerlines 602 and 604. Thresholds 608-614 can be read-stop and/or write-stop thresholds. The read-stop and write-stop thresholds can be different and usually, the read-stop threshold, when present, is much higher than the write-stop threshold.

While reading or writing data along data track centerline 602, if a portion of element 616 is positioned at a location beyond threshold 608 or 610, the servo controller can inhibit or interrupt the corresponding operation. It will be appreciated by those of ordinary skill in the art that reading and/or writing can be inhibited when a position of a region of the head, such as a central region, an outer region, or any other region reaches or exceeds a threshold. Additionally, writing and/or reading can be inhibited when a position of a read element or a write element reaches or exceeds the threshold. Furthermore, an actual, measured, or predicted position of the head or element can be compared to the thresholds to determine whether to inhibit the operation.

In one embodiment, position thresholds 608-614 can be combined with velocity thresholds to define thresholds for a state of the system. For example, a head or element velocity can be measured and/or predicted in addition to measuring and/or predicting a position of the head or element. If the state of the system as defined by the predicted and/or measured position and velocity is not within the threshold (velocity and position), the corresponding operation can be inhibited. Thresholds expressed as combinations of distance and velocity can be dynamic, wherein the individual parameters of the threshold change in relation to the other parameters. For example, for a first head velocity parameter of the threshold, a first position parameter can be used. If the head or element is not within the first velocity and first position parameter, an operation can be inhibited. At a second larger head velocity parameter, a second smaller position parameter can be used for the threshold. Thus, if the head velocity is not within the larger velocity parameter, the operation can be inhibited when the position of the head is not within the smaller position parameter.

At certain times during drive operation, a head, element, or actuator may be considered less stable. During these times, it is more likely than during normal operation of the drive that the head may travel away from a desired or target location. For example, the position of a head or element may be considered less stable and the head or element more likely to move from a desired location after completing a seek (entering a track-following mode from a seek mode), after recovering from or detecting a shock, after recovering from or detecting a read or write fault, and after an estimator saturation error (Many servo systems utilize an estimator in their control loop. The estimator can be used to predict physical parameters of the system such as position, velocity, acceleration etc. In a disk drive system, it is common to measure the position and then compare this measured position to the predicted position. This difference is called estimator error and is a measure of how close the head is to where the servo thought it would be. The estimator error is fed back into the estimator and is used as a correction factor. When the estimator error is greater than a certain number, for example, 20% of a track, it can be mathematically saturated to prevent erroneous position errors from disturbing the system. When this happens, the event is called an estimator saturation error and can be due to an unexpected external disturbance or a bad position detection. In either case, it can trigger a transfer stoppage and recovery, similar to a bump caused by the PES greater than the PES threshold). During these times, a larger variation in values ofthe PES from one sample to the next can be observed. After a seek, fault, shock, etc., the motion of the actuator arm can excite high frequency resonance. These high frequency resonance can cause a larger variation in the position of a head or element than during a normal track-following operation for example. As a result, a larger variation in the measured value of the PES between samples will exist. The larger variation in head position and values of the PES can have deleterious effects on drive performance. For example, a write-stop threshold may be set to 10% of the track pitch. If the servo controller detects a PES value indicating a head position at or beyond the threshold, the servo controller can stop or inhibit the data write operation. However, because of the large variation in head position during these times and a delay between detecting the position and stopping the operation, the operation may not be stopped until the head position is at 20% of the track pitch.

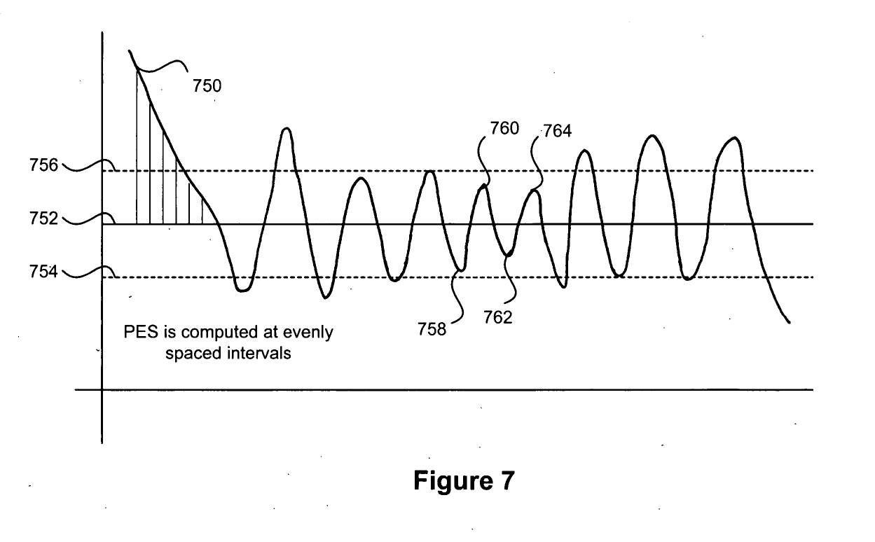

FIG. 7 is a graph illustrating an exemplary PES 750 plotted against time as a head of a disk drive settles onto a selected track in order to enter a track following mode for reading or writing data on the selected track. FIG. 7 can illustrate a PES as a head completes a seek operation or recovers from a shock, fault, estimator saturation error, etc. and settles onto the target track. The PES 750 is large at the beginning of the time period shown, decreases and then oscillates about a value identifying the selected track center as the head settles onto the selected track. PES value 752 can be representative of a centerline of the selected track. PES values 754 and 756 can be threshold values of the PES 750 used in determining when the seek operation should end or when the system should be considered recovered from an error such that a track-following mode can begin.

For example, the positions used for PES computation can be sampled at intervals of time during a seek operation or after an error has occurred (e.g., write fault). The seek operation can end when some specified number of samples, e.g. four to six, of the PES are between the threshold values of the PES. By waiting until some number of samples of the PES are within threshold values to end seek operations and/or begin track following operations, reliability of data written and read can be maintained. A track-following mode can begin after a number of samples of the PES are within the threshold values. Note that this threshold doesn't have to be the same as the transfer inhibit threshold (or bump limit). The seek ends when the end of seek criteria are met, whatever those happen to be.

In the example shown, consecutive PES samples 758-764, within threshold values 754 and 756, can indicate that a track-following mode should begin. As illustrated, however, the value of the PES increases and shows greater fluctuation at a time following the last PES sample. As previously described, this could be due to an increased amount of energy present in the actuator arm following a seek or error recovery. This larger PES and fluctuation is indicative of greater head movement. Consequently, reading and/or writing data away from a desired location may be more likely to occur.

In one embodiment, a tighter threshold can be used for a period of time after beginning a track-following mode or operation. For example, after ending a seek or recovering from a fault, shock, or estimation saturation error, a tighter threshold can be used to inhibit data transfer operations. In this manner, reading and writing data during these times can be more reliable. Tightened, as used herein, can refer to requiring more stringent criteria for thresholds. For example, a threshold may be tightened by establishing a threshold position closer to a track centerline or using a lower velocity than a nominal, averaged, statistical, predicted, or predetermined value. Likewise, in embodiments including a combination of parameters as a threshold, one or more of the parameters can be set to a more stringent criterion in order to tighten the threshold. Numerous methods can be used in accordance with embodiments to tighten thresholds.

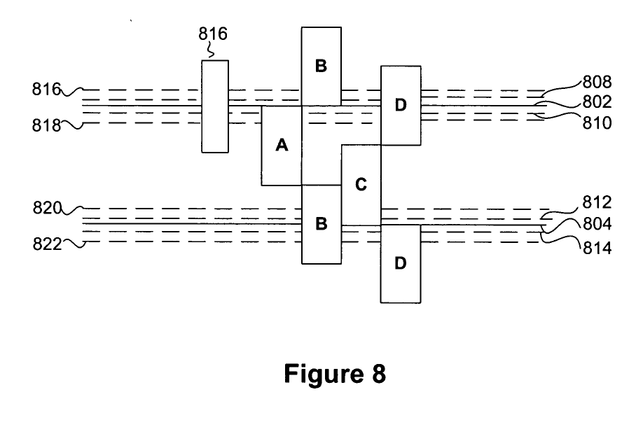

FIG. 8 illustrates a servo pattern that can be used to identify track centerlines 802 and 804. Thresholds 816-822 can be established such that a servo controller can inhibit reading and/or writing during data transfer operations to the tracks identified by centerlines 802 and 804 when a head is not within the thresholds. In accordance with an embodiment, tighter thresholds 808-814 can be established and used to inhibit reading and/or writing during data transfer operations for a period of time after beginning a track-following mode.

In one embodiment, the tighter thresholds can be used for a period of time after beginning a track-following mode. For example, the tighter thresholds can be used after completing a seek mode (ending a seek operation) and beginning a track-following mode or a data transfer operation. The tighter thresholds can be used after the head is sufficiently settled over the target track (e.g., after the end-of-seek criteria has been met) and the track-following mode has begun. In another embodiment, the tighter thresholds can be used after the system or drive has recovered from or detected a shock, write or read fault, or estimator saturation error.

In one embodiment, the tighter thresholds are used for a limited period of time or for a limited number of revolutions (or fraction thereof) of the rotatable storage media. For example, after beginning a track-following mode, the tighter thresholds can be used for a period of time that it takes the head to pass over a specified number of servo wedges. In one embodiment, the number of servo wedges can be one. In another embodiment, the number of servo wedges can be equal to the total number of servo wedges on the media. In other embodiments, the period of time can be equal to the time for the rotatable storage medium to make or spin any number or fraction of revolutions. For example, the tighter thresholds can be used for the first two revolutions of the media after a track-following mode has begun.

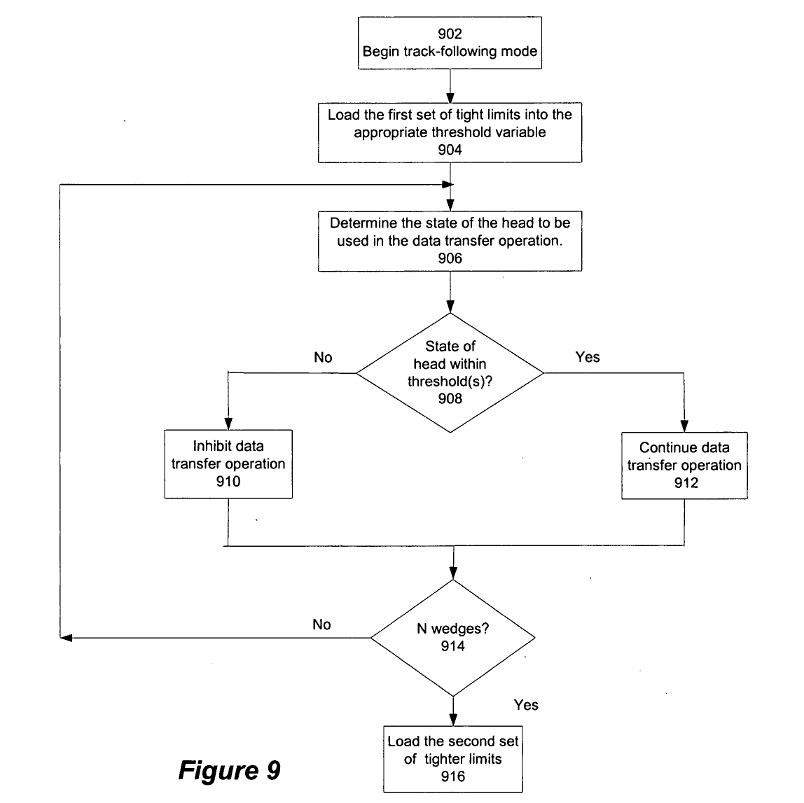

FIG. 9 is a flowchart in accordance with an embodiment for performing a data transfer operation in a system including a rotatable storage medium. At step 902, a track-following mode begins. At step 904, the first set of tight limits is loaded into the appropriate threshold variables, for example, to either write threshold or read threshold variables. Later, it can be determined whether the criteria for loading the second set of tighter thresholds is met. In one embodiment, a control mechanism can determine whether one of the events as previously described is met. For example, the control mechanism can determine whether a seek operation or seek mode ended just prior to entering the track-following mode. Likewise, the control mechanism can determine whether the system has detected or recently recovered from a shock, write or read fault, or estimator saturation error. If it is determined that one of these conditions is met, the control mechanism can determine whether the system is in a specified period of time since the occurrence of one of these events and/or entering the track following mode. For example, at step 914, the control mechanism can determine whether N servo wedges have been encountered by a read element since the track-following mode started or a number of revolutions of the rotatable storage medium. If one of the specified events has occurred and the time period has not elapsed, the tighter thresholds will be loaded at step 916 and the remaining portion of the data transfer operation will continue to proceed.

After a set of limits has been loaded, a state of a head or element to be used in the data transfer operation can be determined at step 906. Determining the state of the head or element can include determining a position ofthe head or element relative to the target data track involved in the operation. In one embodiment, determining the element position comprises determining a distance between a location of the element and a centerline of the target data track. A value of the PES generated as a read element reads servo information can be used to identify the distance. Additionally, a velocity of the head, element, or actuator arm can be determined as part of determining the state ofthe head or element. The state of the head or element determined at step 906 can be a measured or predicted state. For example, sampled values of the element position and/or velocity can be used to predict a subsequent position and/or velocity. Sampled values ofthe PES can be used to predict a subsequent position, velocity, or PES value.

At step 908, it can be determined whether the state of the head or element is within the threshold. If the threshold is expressed as a position, the position of the element determined at step 906 can be compared to the threshold position. In one embodiment, comparing the position can include comparing the distance of the element from the target track centerline to a threshold distance measured from the target track centerline. The determination at step 908 can include comparing a measured or predicted PES value with a threshold PES value. If the threshold is expressed as a velocity, the velocity determined at step 906 can be compared to the threshold velocity. Similar comparisons can be made for thresholds including multiple parameters such as position and velocity.

If the state of the head or element is not within the tighter threshold, the data transfer operation can be inhibited at step 910. After the data transfer operation is inhibited, there can be a variety of ways to allow transfers to happen again, for example, in some cases, the servo is forced to go through end of seek criteria to ensure everything is ok before allowing the transfer to continue.

If the state of the head or element is within the threshold, the data transfer operation can continue at step 912. Continuation of the data transfer operation can include writing or reading data during all or a portion of the operation. For example, user data can be written for a pre-determined portion of a revolution of the media or for a pre-determined number of data sectors after determining that the write element is within the threshold. In various embodiments, continuation of the data transfer operation can simply include enabling or not disabling reading or writing of user data in accordance with another transfer operation technique.

Many features of the present invention can be performed using hardware, software, firmware, or combinations thereof. Consequently, features of the present invention may be implemented using a control mechanism including one or more processors, a disk controller, or servo controller within or associated with a disk drive (e.g., disk drive 100). The control mechanism can include a processor, disk controller, servo controller, or any combination thereof. In addition, various software components can be integrated with or within any of the processor, disk controller, or servo controller.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer or disk drive to perform any of the features presented herein. The storage medium can include, but is not limited to, any type of disk including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular ICs), or any type of media or device suitable for storing instructions and/or data.

Stored on any one of the computer readable medium (media), the present invention includes software for controlling both the hardware of the general purpose/specialized computer, microprocessor, disk drive, and/or for enabling the computer or microprocessor to interact with a human user of other mechanism utilizing the results of the present invention. Such software may include, but is not limited to, device drivers, operating systems, execution environments/containers, and user applications.

In one embodiment, a system is implemented exclusively or primarily in hardware using, for example, hardware components such as application specific integrated circuits (ASICs). Implementation of the hardware state machine so as to perform the functions described herein will be apparent to persons skilled in the relevant art(s).

Although embodiments described herein refer generally to systems having a magnetic disk, any media, or at least any rotating media, upon which information is written, placed, or stored, may be able to take advantage of embodiments of the invention, as re-writing in accordance with embodiments in optical, electrical, magnetic, mechanical, and other physical systems can be performed.

Although various embodiments of the present invention, including exemplary and explanatory methods and operations, have been described in terms of multiple discrete steps performed in turn, the order of the descriptions should not necessarily be construed as to imply that the embodiments are order dependent. Where practicable for example, various operations can be performed in alternative orders than those presented herein.

The foregoing description of embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

1. A method of executing a data transfer operation involving a target track of a rotatable storage medium, comprising:
positioning a head relative to the target track;
determining, during a fist period of time, whether the head is within a first threshold;
inhibiting the data transfer operation while the head is not within the first threshold during the first period of time;
determining, during a second period of time, whether the head is within a second threshold; and
inhibiting the data transfer operation while the head is not within the second threshold during the second period of time.

2. The method of claim 1, wherein the step of determining, during a first period of time, whether the head is within a first threshold, comprises:
determining whether a position of the head is within a first threshold position.

3. The method of claim 2, wherein the step of determining whether a position of the head is within a first threshold position comprises:
determining whether a predicted position of the head is within a first threshold position.

4. The method of claim 1, wherein the step of determining, during a first period of time, whether the head is within a first threshold, comprises:
determining a distance of a portion of the head from a centerline of the target track; and
determining whether the distance is within a threshold distance.

5. The method of claim 1, wherein the step of determining, during a first period of time, whether the head is within a first threshold, comprises:
determining whether a value of a position error signal generated as a read element reads servo information is within a threshold position error signal value.

6. The method of claim 5, wherein the value of the position error signal is at least one of a predicted value of the position error signal and a measured value of the position error signal.

7. The method of claim 1, wherein the step of determining, during a first period of time, whether the head is within a first threshold, comprises:
determining whether a velocity of the head is within a threshold velocity.

8. The method of claim 1, wherein the first threshold is tighter than the second threshold.

9. The method of claim 1, wherein the second threshold is a nominal threshold.

10. The method of claim 1, further comprising:
beginning a track-following mode after positioning the head relative to the target track.

11. The method of claim 10, further comprising:
ending a seek mode prior to beginning the track-following mode.

12. The method of claim 1, wherein the first period of time is a first period of time after ending a seek mode.

13. The method of claim 1, wherein the rotatable storage medium is located in a device, further comprising:
detecting a shock to the device;
wherein the first period of time is a first period of time after detecting the shock.

14. The method of claim 1, further comprising:
determining that at least one of a read fault and a write fault has occurred prior to positioning the head relative to the target track;
wherein the first period of time is a first period of time after determining that at least one of the read fault and the write fault has occurred.

15. The method of claim 1, further comprising:
determining that an estimator saturation error has occurred;
wherein the first period of time is a first period of time after determining that the estimator saturation error has occurred.

16. The method of claim 1, wherein the first period of time is equal to a time it takes for the rotatable storage medium to make a number of revolutions.

17. The method of claim 16, wherein the number of revolutions is one.

18. The method of claim 16, wherein the number of revolutions includes a fraction of a revolution.

19. The method of claim 1, wherein the first period of time is equal to a time it takes a read element to pass over a number of servo wedges of the rotatable storage medium.

20. The method of claim 1, wherein the data transfer operation comprises:
writing data to the rotatable storage medium.

21. The method of claim 1, wherein the data transfer operation comprises:
reading data from the rotatable storage medium.

22. The method of claim 1, wherein the head includes at least one of a read element and a write element.

23. The method of claim 1, further comprising:
enabling the data transfer operation while the head is within the first threshold during the first period of time; and
enabling the data transfer operation while the head is within the second threshold during the second period of time.

24. A method of executing a data transfer operation involving a target track of a rotatable storage medium, comprising:
positioning a head relative to the target track;
determining whether the head is within a first threshold during a first period of time;
enabling the data transfer operation while the head is within the first threshold during the first period of time;
determining whether the head is within a second threshold during a second period of time; and
enabling the data transfer operation while the head is within the second threshold during the second period of time.

25. The method of claim 24, wherein the first threshold is tighter than the second threshold.

26. A method of executing a data transfer operation involving a target track of a rotatable storage medium, comprising:
determining whether a criterium is met for applying a first threshold during a portion of the data transfer operation;
enabling the data transfer operation while a head to be used in the data transfer operation is within the first threshold when the criterium is met; and
enabling the data transfer operation while the head is within a second threshold when the criterium is not met.

27. The method of claim 26, wherein the first threshold is tighter than the second threshold.

28. The method of claim 26, wherein the step of determining whether a criterium is met comprises:
determining whether a period of time has elapsed since a seek mode ended;
wherein the criterium is met if the period of time has not elapsed.

29. The method of claim 26, wherein the step of determining whether a criterium is met comprises:
determining whether at least one of a read fault, a write fault, a shock, and a estimator saturation error has been detected;
determining whether a period of time has elapsed since detection of the read fault, the write fault, the shock, and the estimator saturation error;
wherein the criterium is met if the period of time since detection has not elapsed.

30. The method of claim 26, wherein the step of determining whether a criterium is met comprises:
determining whether at least one of an end-of-seek, a read fault, a write fault, a shock, and an estimator saturation error has occurred;
determining whether the rotatable storage medium is within a number of revolutions since the occurrence of the end-of-seek, read fault, write fault, shock, or estimator saturation error;
wherein the criterium is met if the rotatable storage medium is within the number of revolutions since the occurrence.

31. A method of executing a data transfer operation involving a target track of a rotatable storage medium, the rotatable storage medium being in a device, comprising:
detecting a disturbance to the device;
positioning a head relative to the target track of the rotatable storage medium after detection of the disturbance;
beginning a track-following mode after positioning the head;
enabling the data transfer operation while the head is within a first threshold during a first period of time after beginning the track-following mode; and
enabling the data transfer operation while the head is within a second threshold during a second period of time after beginning the track-following mode.

32. The method of claim 31, wherein the disturbance includes at least one of an end of a seek mode, a write fault, a read fault, a shock, and an estimator saturation error.

33. A method of executing a data transfer operation involving a target track of a rotatable storage medium, comprising:
positioning a head relative to the target track;
determining whether the head is within a threshold, the threshold including at least two threshold settings; and
enabling the data transfer operation while the head is within the threshold;
wherein the data transfer operation is enabled while the head is within a tighter threshold setting after detection of a shock involving the rotatable storage medium.

34. The method of claim 33, wherein the data transfer operation is enabled while the head is within a tighter threshold setting for a period of time after detection of a shock involving the rotatable storage medium.

35. The method of claim 34, wherein the period of time is equal to a time it takes the rotatable storage medium to make a number of revolutions.

36. The method of claim 34, wherein the period of time is equal to a time it takes a read element to pass over a number of servo wedges of the rotatable storage medium.

37. The method of claim 35, wherein the shock includes a physical force, the physical force causing a position-error of the head.

38. A method of executing a data transfer operation involving a target track of a rotatable storage medium, comprising:
positioning a head relative to the target track;
determining whether the head is within a threshold, the threshold including at least two threshold settings; and
enabling the data transfer operation while the head is within the threshold;
wherein the data transfer operation is enabled while the head is within a tighter threshold setting after a seek operation to the target track.

39. A method of executing a data transfer operation involving a target track of a rotatable storage medium, comprising:
positioning a head relative to the target track;
determining whether the head is within a threshold, the threshold including at least two threshold settings; and
enabling the data transfer operation while the head is within the threshold;
wherein the data transfer operation is enabled while the head is within a tighter threshold setting after detection of at least one of a write fault and a read fault.

40. In a method including a rotatable storage medium, the system including at least one head for transferring data with the rotatable storage medium and a control mechanism for enabling the head to transfer data with the rotatable storage medium, the method comprising:
enabling the head to transfer data with the rotatable storage medium while the head is within a threshold, the threshold including at least two threshold settings;
wherein the head is enabled to transfer data with the rotatable storage medium while the head is within a tighter threshold setting after detection of a shock to the system.
